(19) United States
(12) Patent Application Publication
(10) Pub. No.: US 2025/0291584 A1
(43) Pub. Date: Sep. 18, 2025

(54) COMMIT GENERATION IN CONTINUOUS INTEGRATION (CI) ENVIRONMENTS

(71) Applicant: Red Hat, Inc., Raleigh, NC (US)

(72) Inventors: Tomas Meszaros, Brno (CZ); Marek Filip, Brno (CZ)

(21) Appl. No.: 18/603,089

(22) Filed: Mar. 12, 2024

(51) Int. Cl. G06F 8/71; G06F 8/73; G06F 11/36

(52) U.S. Cl. CPC G06F 8/71; G06F 8/73; G06F 11/368

(57) ABSTRACT

Techniques for processing change requests for software projects are disclosed. An example method includes receiving a change request describing new source code for a software project. The method also includes generating, by a processing device, a prompt comprising context information and a plugin, wherein the context information comprises source code from the software project and the plugin comprises text that describes a supplemental work product to be generated. The method also includes providing the prompt to a machine learning model, wherein the context information trains the machine learning model to provide the supplemental work product with a correct content and format. The method also includes receiving the supplemental work product from the machine learning model. The method also includes applying the supplemental work product to the software project.

### TECHNICAL FIELD

Aspects of the present disclosure relate to source code management, and more specifically to processing requests for changes to source code.

### BACKGROUND

Source code is a fundamental component of a computer program that is created by a programmer. Large software projects may include several software modules that are written by a group of programmers. The generated source code may be stored to a source-code repository, which may be maintained by source code management (SCM) system that archives source code, documentation, web pages, and other works, accessible either publicly or privately. Such SCM systems are often used by open-source software projects and other multi-developer projects to maintain revision and version history, or version control.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram of an example computing system in accordance with some embodiments of the present disclosure.

FIG. 2 is a process flow diagram for a method of processing a change request, in accordance with some embodiments of the present disclosure.

FIG. 3 is another process flow diagram for a method of processing a change request, in accordance with some embodiments of the present disclosure.

FIG. 4 is a method of committing a change request to a codebase of a software project, in accordance with some embodiments of the present disclosure.

FIG. 5 is a block diagram of a system for committing a change request to a codebase of a software project, in accordance with some embodiments of the present disclosure.

FIG. 6 is a block diagram of an example computing device that may perform one or more of the operations described herein, in accordance with some embodiments of the present disclosure.

### DETAILED DESCRIPTION

Aspects of the present disclosure relate to techniques for processing requests to change source code within a software project. Software projects may include several modules of source code that operate together and are sometimes referred to as a codebase. The source code is usually generated and updated by code developers that contribute source code by submitting requests for changes to the codebase. Such requests to make changes to the codebase are often referred to as pull requests. Requests for changes may be raised against a source code management (SCM) system, which can that keep track of different versions of the project and enable several developers to collaborate and contribute code. The source code management system may also be coupled with a continuous integration (CI) environment that manages the integration of code changes from multiple contributors and merges code changes into a central repository where the code can be executed and tested. In continuous integration environments, projects are constantly tested to detect and prevent regressions in terms of functionalities and/or performance.

Code contributions are usually beneficial in that new functionalities can be added, existing ones can be tuned, and existing bugs or security vulnerabilities can be fixed or prevented. Change requests may be implemented using a difference file (sometimes referred to as a diff file of diff patch), which documents the specific code insertions and deletions made to each line of code. The difference file can be processed by a patch utility, which implements each of the changes shown in the diff file.

To ensure that the code changes do not introduce code faults, changes requests are often reviewed by developers and/or tested to ensure that that the code operates as intended. For example, software tests referred to as unit tests may be performed for any unit of code that is affected or changed by a change request. Unit testing may be performed in accordance with one or more unit tests (also referred to herein as test cases) that describe inputs, execution conditions, testing procedures, and expected results of a single test to be executed to verify performance of the of the unit of code.

When a developer submits a change request, the developer is usually expected to submit the corresponding software tests to be used to test the parts of the code that are changed or affected by the change request. Additionally, the developer is usually expected to submit documentation that explains the changes that were made to the code. The documentation and software tests for the new code are usually written by the developer submitting the change request. This process can be time-consuming, error-prone, and often leads to delays in the development cycle. Moreover, ensuring that the written tests and documentation are comprehensive and adhere to best practices is challenging, requiring significant effort and expertise.

Aspects of the disclosure address the above-noted and other deficiencies by providing an automated system that can generate software tests, documentation, and other supplemental work product for new code submissions automatically and incorporate this supplemental work product directly into the open change request. As used herein, the term “automatic,” “automatically,” etc. refers to an automated process that is performed without human interaction.

In accordance with embodiments of the present techniques, a source code management system can include or have access to a large language model (LLM). Upon receipt of a change request, the source code management system can generate one or more prompts to be applied to the LLM to cause the LLM to generate various types of requested text documents. The prompts may include a text string referred to herein as a plugin. The plugin may be a specified to request the production of a particular type of supplemental work product, such as a software tests, feature documentation, and others.

The prompts may also include context information, which serves as a sort of training data set used to improve the relevance and accuracy of the LLM model output. The context information may include the entire codebase of a software project or relevant portions of the codebase. The amount of context information that the LLM can receive will depend on the memory limitations of the LLM (e.g., context window). The generated documents can be incorporated into the change request along with the code updates. In some embodiments, the generated documents may be reviewed and further enhanced by the content developer. However, even if the developer rewrites or corrects some of the generated testing code of software documentation, the overall development process will be much more efficient, fast, accurate, and consistent compared to manual document and code generation.

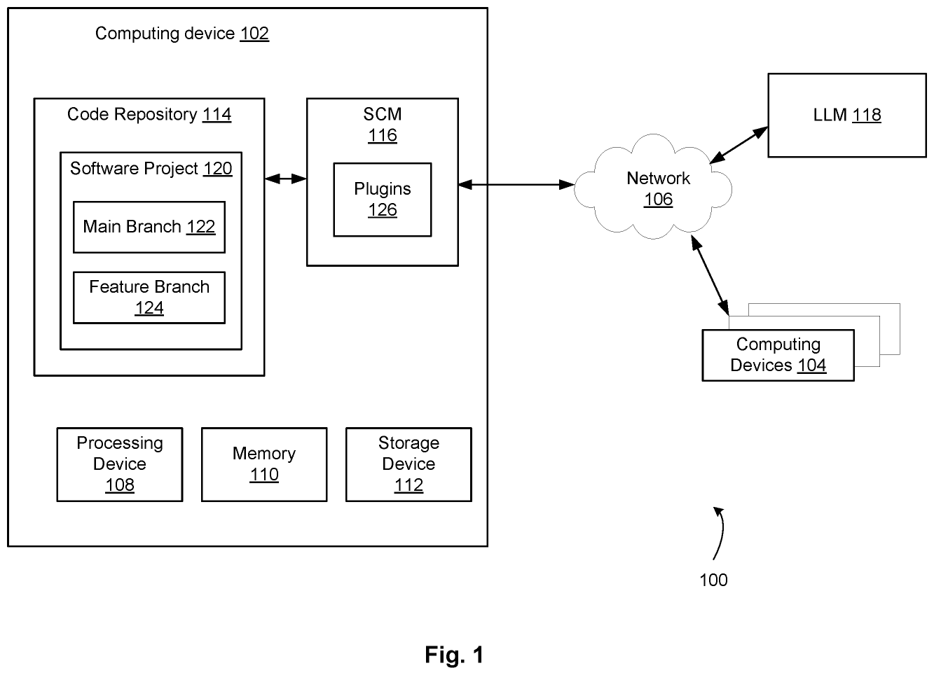

FIG. 1 is a block diagram of an example computing system 100 in accordance with some embodiments of the present disclosure. One skilled in the art will appreciate that other architectures are possible for system 100 and any components thereof, and that the implementation of a system utilizing examples of the invention are not necessarily limited to the specific architecture depicted by FIG. 1. The system 100 may be a cloud-based infrastructure or non-cloud-based system such as a personal computer, one or more servers communicatively coupled through a network, and other configurations. The system 100 may include a computing device 102 and computing devices 104, which may be coupled to each other (e.g., may be operatively coupled, communicatively coupled, may communicate data/messages with each other) via network 106.

The computing device 102 can include one or more processing devices 108 (e.g., central processing units (CPUs), graphical processing units (GPUs), etc.), main memory 110 which may include volatile memory devices (e.g., random access memory (RAM)), non-volatile memory devices (e.g., flash memory) and/or other types of memory devices, and a storage device 112 (e.g., one or more magnetic hard disk drives, a Peripheral Component Interconnect (PCI) solid state drive, a Redundant Array of Independent Disks (RAID) system, a network attached storage (NAS) array, etc.). In certain implementations, main memory 110 may be non-uniform access (NUMA), such that memory access time depends on the memory location relative to processing device 108. The storage device 112 may be a persistent storage and may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. The storage device 112 may be configured for long-term storage of data and may retain data between power on/off cycles of the computing device 102. It should be noted that although, for simplicity, a single processing device 108, main memory 110, storage device 112, are shown, other embodiments may include a plurality of processing devices, memories, storage devices, and devices. Additionally, the computing device 102 may have additional components not shown in FIG. 1. Computing devices 104 may comprise similar architectures.

Network 106 may be a public network (e.g., the internet), a private network (e.g., a local area network (LAN) or wide area network (WAN)), or a combination thereof. In one embodiment, network 106 may include a wired or a wireless infrastructure, which may be provided by one or more wireless communications systems, such as a WiFi™ hotspot connected with the network 106 and/or a wireless carrier system that can be implemented using various data processing equipment, communication towers (e.g. cell towers), etc. In some embodiments, the network 106 may be an L3 network. The network 106 may carry communications (e.g., data, message, packets, frames, etc.) between computing devices 102 104.

The computing device 102 may be used for software development and version control. The computing device 102 may include or have access to a code repository 114 that store modules of source code, which may be organized into one or more software projects 120. Each software project 120 may include several interoperable source code modules that can be merged together and used to serve various functions. The source code may be written in any suitable language, including Python, Java, Javascript, C, C+, C++, and others. The software project 120 may include a main branch 122 and one or more feature branches 124. A feature branch 124 is a copy of the main branch 122 that can be created to develop and test new versions of the software project 120.

The source code modules stored to the code repository 114 may be accessed by one or more software developers via the computing devices 104. For example, code contributors are able to access source code and make programming changes to the source code through change requests. Change requests may be sent to computing device 102 through a source code manager (SCM) 116, which provides various functions including version control, for example. The SCM 116 may be configured to track changes to source code, commit source code changes to the code repository 114, backup and restore source code files, undo source code changes, and other functions. In some embodiments, the SCM 116 can be a Git-based version control system such as GitHub, SourceForge, GitLab, and others. User's can send instructions to the SCM 116 using a predefined command format (e.g., Git format) specific to the type of version control system.

In various embodiments, source code changes committed to the code repository 114 include metadata such as a unique author ID that identifies the developer who authored the code and a commit message that describes the change. Contributors and reviewers can also use the SCM 116 to pull selected source code modules for editing and/or testing, in which case the SCM 116 can ensure that the latest version of the source code is being provided. The SCM 116 may also enable contributors to create feature branches, which are separate versions of the code that can be manipulated without affecting the main code (e.g., the main branch 122). Code contributors can commit changes to the code in the feature branch 124, which can be tested and reviewed before the new code in the feature branch 124 is pushed to the main code. Various additional functionalities may be provided by the SCM 116.

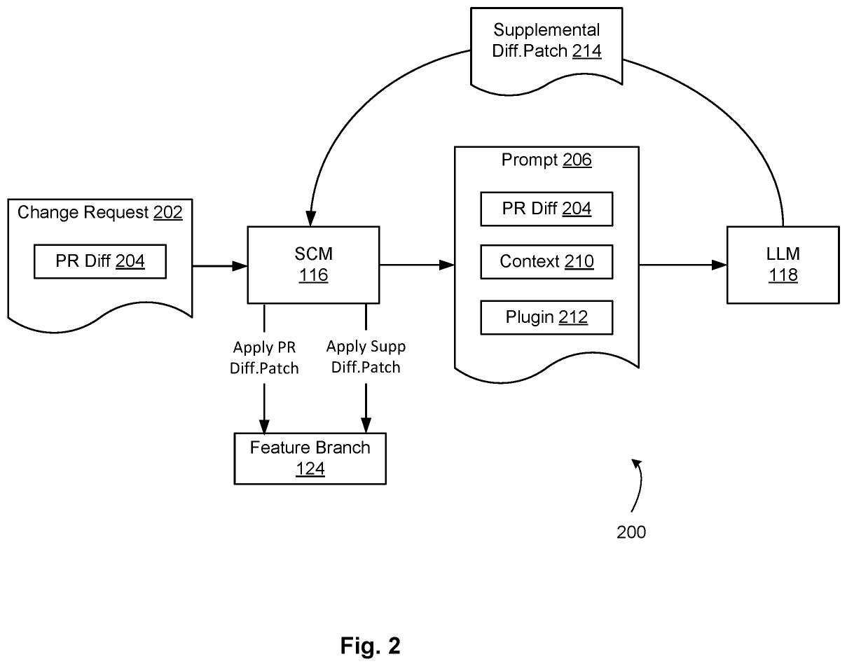

In a typical source code update scenario, a contributor may send a change request to the SCM 116. The change request may include a difference file that described the changes to the source code. The SCM 116 can then generate the new code using the difference file and commit the new version of the code to a feature branch 124. As explained further in relation to FIG. 2, the SCM 116 also uses the difference file to generate supplemental work product related to the new code. The supplemental work product may be any type of documents, files, computer code, text, or other information that can be inferred, at least in part, from the difference file.

Examples of supplemental work product include unit tests and feature documentation. Unit testing is a process for testing an individual unit of code to ensure that the code operates in accordance with expectations. A unit of code may refer to a function, procedure, object, class, code module or file, etc. The written unit tests generated by the SCM 116 may specify a plurality of test cases, where each test case describes specific inputs, execution conditions, testing procedures, and expected results of a single test to be executed to verify performance of the of the unit.

Feature documentation refers to a description of the code changes implemented by a difference file. The documentation may include comments that are embedded in the new code for each code change. For example, if a line of code is added or removed by the difference file, the documentation may include a comment at the relevant location in the source code explaining what was added or removed and, optionally, the reason for the change and the effect that the change will have.

In accordance with embodiments of the present techniques, the SCM 116 generates the supplementary work product automatically by engaging a large language model (LLM) 118, which may be accessed by the SCM 116 through the network 106. The LLM 118 may be any suitable type of machine learning model or artificial neural network trained to generate language in response to prompts, such as the OpenAI generative pre-trained transformer (GPT) and others.

Upon receipt of a change request, the SCM 116 may construct a custom prompt, which may include the difference file associated with the change request, context information from the code repository 114, and a plugin 126 that specifies a particular type of supplemental work product to be generated by the LLM 118. The custom prompt may be generated by the SCM 116 automatically based on characteristics of the change request as described further below in relation to FIG. 2. The custom prompt is then sent to the LLM 118, which generates the supplemental work product and returns to the SCM 116.

The supplemental work product received from the LLM 118 may be added (e.g., committed) to the change request. In some embodiments, the contributor of the change request can review the additional information for accuracy and completeness and may optionally make additional changes. The change request may then be pushed to the feature branch 124, which may be flagged as requiring testing or review. Various software testing operations (e.g., unit tests) may be performed in accordance with the unit tests generated by the SCM 116 and included in the change request.

In some cases, one or more rounds of testing may also be performed on the source code. The testing may involve running the software module alone and/or in combination with other source code modules in the project and collecting data related to software performance. Once the source code has been reviewed, tested, and determined to be acceptable, the source code of the feature branch 124 can be pushed to the main branch 122 of the software project 120.

FIG. 2 is a process flow diagram for a method of processing a change request, in accordance with some embodiments of the present disclosure. The method 200 may be implemented in hardware or a combination of hardware and software and any suitable type of computing architecture. In some embodiments, the method 200 may be performed, at least in part, by a system for managing source code, such as the SCM 116 of FIG. 1.

The SCM 116 can receive a change request 202 from a developer. The change request includes a difference file, shown in FIG. 2 as pull request (PR) diff 204. The change request 202 may also include additional information such as a unique developer ID, comments that describe the changes implemented by the source code, and other types of metadata.

Upon receiving the change request 202, the SCM can process the change request 202 to generate a PR diff patch, which is a text document that describes how to alter an existing file or codebase. The SCM 116 can apply the PR diff patch to the relevant feature branch to generate new source code for the new version of the software project.

The SCM 116 also generates the prompt 206, which is input to the LLM 118 to elicit the generation of the supplemental work product, such as unit tests, feature documentation, and others. The prompt 206 may include the difference file (PR diff 204), context information 210, and a plugin 212.

The context information 210 may include code from the code repository 114 and is provided to the LLM 118 to elicit the correct type of response in the correct format. This context information 210 serves as a type of additional training data that biases the LLM 118 to generate language that conforms to the requested information style and format. For example, unit tests included in the context information 210 can serve as examples that train the LLM 118 to recognize the expected content to be provided and the proper format for the content in response to a request for unit tests.

The SCM 116 may generate the context information automatically by selecting relevant portions of the code repository 114 based on the change request 202 and/or the difference file. For example, SCM 116 may retrieve the entire software project 120 targeted by the change request 202 and send this to the LLM 118 as context information 210. In some embodiments, the SCM 116 may limit the context information to the particular code units (procedures, functions, subroutines, objects, modules, etc.) that are changed by the change request 202. Other variations are also possible. The particular portions of the code repository used as context information may depend in part on the LLM's context length limit, which is the largest prompt size that the LLM can take into account when making predictions.

The plugin 212 may be a text string configured as a request for the supplemental work product. The plugin 212 may be specified by the user and/or selected automatically from a set of predefined plugins, each configured to elicit a different type of work product. Example plugins may include text strings such as those shown in Table 1 below:

TABLE 1
Example text strings for a plugin.

“write tests”
“write end-to-end tests”
“write unit tests”
“write comments for each function”
“write documentation for the new feature”
“remove all comments from the new code”
“fix typos and grammar errors in documentation and comments”
“add explanation comments to lines of code or functions”

The SCM 116 may select the plugin 212 based on information included in the change request 202. For example, the change request 202 may include metadata that identifies a particular type of supplemental work product that is being requested by the user that submitted the change request 202. In some embodiments, the SCM 116 may select the plugin based on the difference file included in the change request 202. For example, the SCM 116 may analyze the PR diff 204 to determine whether unit tests are included in the PR diff 204. If unit tests are not included, the SCM 116 may select the “write unit tests” plugin. In some embodiments, the plugin 212 may be predetermined according to the programming of the SCM 116 such that the SCM 116 is configured to request a certain type of supplemental work product for each change request received. For example, the SCM 116 may request unit tests and code documentation for each change request, in which case the list of plugins may include a first plugin defined as “write unit tests” and a second plugin defined as “write documentation for the new feature.” The SCM 116 may send two prompts to the LLM 118 for the change request 202, one which uses the first plugin and an additional prompt that uses the second plugin. In this example, the SCM 116 would receive two responses with two different types of supplemental work product packaged as two separate supplemental diff patches.

The PR diff 204, context 210, and plugin 212 may be concatenated to form the prompt 206. For example, the prompt may be a text string structured as follows:
“
Codebase:
File A: {contents of file A from code repository}
File B: {contents of file B from code repository}
File C: {contents of file C from code repository}
{Plugin} for {PR Diff} in a correct Git commit format
”

In the prompt example above, the context portion of the prompt 206 starts with the word “codebase” and includes three files (A, B, and C) and the contents of these files are represented by the placeholders “{ . . . }”. The request portion of the prompt 206 includes the plugin 212 and the difference file, PR Diff 204. Specifically, the {PR Diff} placeholder represents the contents of the PR diff 204 that contains the changes to the codebase that the developer has submitted, and the {Plugin} placeholder represents the action that is being requested in relation to the difference file, PR Diff 204. For example, the request portion of the prompt may be “write unit tests for {PR diff} in a correct Git commit format.” In this example, the request portion of the prompt requests that the output be generated in accordance with the Git commit format. Various wording changes may be made to the prompt 206 without deviating from the scope of the present disclosure. For example, a different format may be requested, and different framing language may be used compared to what is shown above. Various techniques may be used to generate the prompt 206, examples of which are described herein. However, it will be appreciated that these are example embodiments and that additional techniques may be implemented without deviating from the scope of the claims.

Once constructed, the prompt 206 may be provided as input to the LLM 118. Although depicted as a single message, it will be appreciated that the prompt 206 may be delivered in a series of messages. For example, the context 210 could be provided in a first message, and the request portion of the prompt 206 could be delivered in a second message. In response, the LLM 118 generates the supplemental work product in the form of a text output that satisfies the conditions of the request portion of the prompt 206. For example, if the selected plugin 212 is a request for feature documentation, the LLM 118 may generate text that describes characteristics of the PR Diff 204 and explains the changes made to the codebase. If the selected plugin is a request for unit tests, the LLM 118 may generate computer code that describes unit tests that can be applied to the code represented by the difference file, PR Diff 204.

The format of the text generated by the LLM 118 may depend on the format requested by the prompt 206. In this example, the output is another patch file, referred to herein as the supplemental diff patch 214. The supplemental diff patch 214 is returned to the SCM 116, which applies the supplemental diff patch to the feature branch 124. An example workflow using git commands for a git-based version control system may implemented be as follows:
1. git checkout feature-branch
2. git apply Supp diff.patch

In this embodiment, the feature branch 124 has already been updated using the PR diff patch to apply the code changes. Accordingly, the SCM 116 checks out the feature branch 124 again and applies the new difference file, supplemental diff patch 214. In other embodiments, the SCM 116 may wait to receive the response from the LLM 118, before checking out the feature branch 124 and then applying both difference files (PR diff patch and supp diff patch 214) before committing changes and pushing the changes to the open feature branch 124.

In some embodiments, the supplemental work product may be reviewed by a human user before being committed to the feature branch 124. For example, the SCM 116 may render a visual display of the supplemental diff patch 214 to a user interface and optionally allow the user to make changes. Once the user approves the supplemental work product, the SCM 116 can continue to apply the supplemental diff patch 214 to the feature branch 124.

It will be appreciated that embodiments of the method 200 may include additional processes and variations not shown in FIG. 2. For example, the SCM 116 may request more than one type of supplemental work product in a series of prompts or in a single prompt with two or more request portions with different plugins. In this example, the context 210 provided to the LLM 118 may be carried over for several requests so that the SCM 116 is able to request several types of supplemental work product without resending the context 210 for each request.

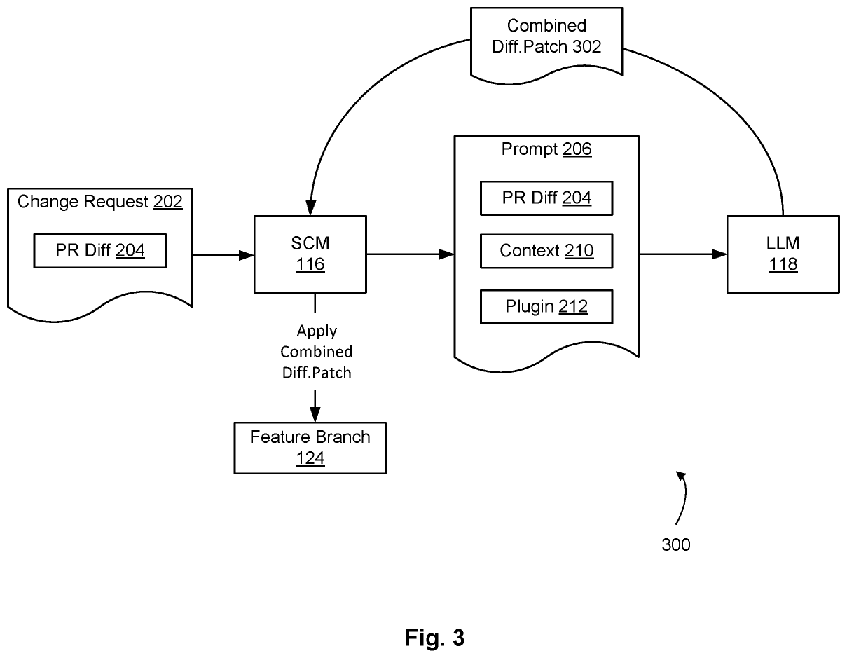

FIG. 3 is another process flow diagram for a method of processing a change request, in accordance with some embodiments of the present disclosure. The method 300 may be implemented in hardware or a combination of hardware a software and any suitable type of computing architecture. In some embodiments, the method 300 may be performed, at least in part, by a system for managing source code, such as the SCM 116 of FIG. 1.

The method shown in FIG. 3 is similar to the method of FIG. 2, with the exception that a single combined difference file is generated and includes the code changes of the original difference file combined with the supplemental work product. As described in reference to FIG. 2, the SCM 116 can receive a change request 202 which includes a difference file, PR diff 204. After receiving the change request 202, the SCM 116 generates the prompt 206, which includes the PR diff 204, code from the code repository 114 as context 210, and the plugin 212. The context 210 may be selected as described above in relation to FIG. 2.

The plugin 212 may be similar to one of the plugins shown in Table 1. However, in this embodiment, the wording of the plugin 212 and/or the request portion of the prompt 206 will cause the LLM 118 to generate a text output that merges the original code changes from the difference file, PR diff 204, with the supplemental work product. For example, the request portion of the prompt may be constructed as “extend {PR diff} by {Plugin} for {PR Diff} in a correct Git commit format.” In this example, the plugin 212 may be “writing unit tests”, “writing code documentation”, etc.

Once constructed, the prompt 206 may be provided as input to the LLM 118. In response, the LLM 118 generates a combined difference patch 302. The combined difference patch 302 includes the original code changes from PR diff 204 and the supplemental work product (e.g., unit tests, comments, feature documentation, etc.). In this embodiment, the SCM 116 may check out the feature branch 124, apply the combined difference patch 302, commit the changes, and push the changes to the feature branch 124. As described above in relation to FIG. 2, the combined difference patch 302 may be reviewed and/or edited by a human user.

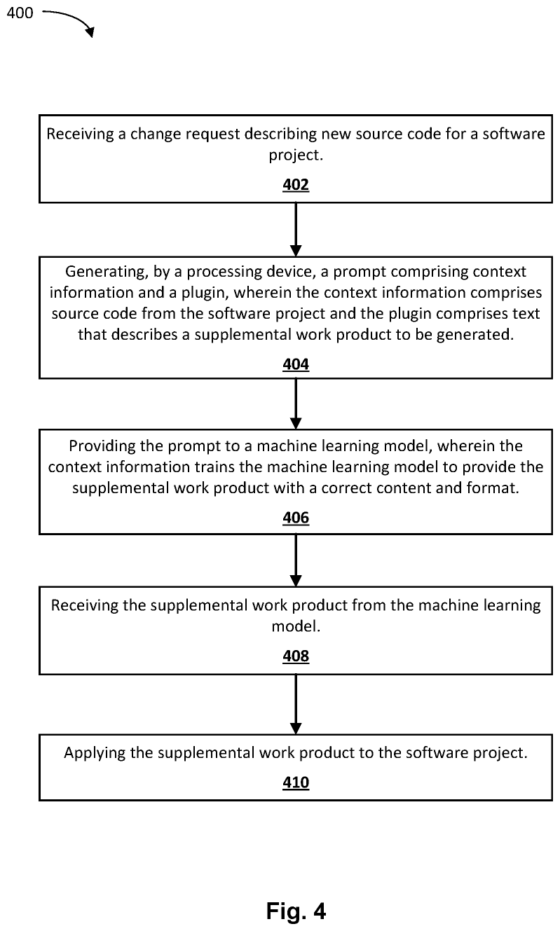

FIG. 4 is a method of committing a change request to a codebase of a software project, in accordance with some embodiments of the present disclosure. Method 400 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed by a source code manager, such as the SCM 116 shown in FIGS. 1-3. The method may begin at block 402.

At block 402, a change request describing new source code for a software project is received. The change request may include a difference file that describes the new source code as code differences (e.g., added lines of code or lines of code to be deleted) relative to a current version of the source code.

At block 404, a prompt comprising context information and a plugin is generated, wherein the context information comprises source code from the software project and the plugin comprises text that describes a supplemental work product to be generated. Generating the prompt may include selecting the plugin from a set of predetermined plugins based on characteristics of the change request, such as the change request metadata or contents of the difference file associated with the change request. The context may be the entire codebase of the relevant software project or selected portions of the codebase. For example, the difference file may be processed to identify units of source code from the software project that are affected by the code differences. The identified units of source code may be added to the context information.

At block 406, the prompt is provided to a machine learning model, wherein the context information trains the machine learning model to provide the supplemental work product with the correct content and format. The machine learning model may a large language model (LLM) or other type of artificial neural network.

At block 408, the supplemental work product is received from the machine learning model. The supplemental work product may be formatted as a supplemental difference patch that can be processed to apply the supplemental work product to the software project. In some embodiments, the supplemental work product may be included in a combined difference patch that includes the code changes and the supplemental work product.

At block 410, the supplemental work product is applied to the software project. The supplemental work product may be applied using a patch utility that can process a difference patch to apply the source code changes identified in the difference patch (e.g., the supplemental difference patch or the combined difference patch of block 408). The supplemental work product may include software tests (e.g., unit tests) to be used to test the new source code associated with the feature branch, code documentation (e.g., feature documentation) describing code changes applied by the change request, and others.

It will be appreciated that embodiments of the method 400 may include additional blocks not shown in FIG. 4 and that some of the blocks shown in FIG. 4 may be omitted. Additionally, the processes associated with blocks 402 through 410 may be performed in a different order than what is shown in FIG. 4.

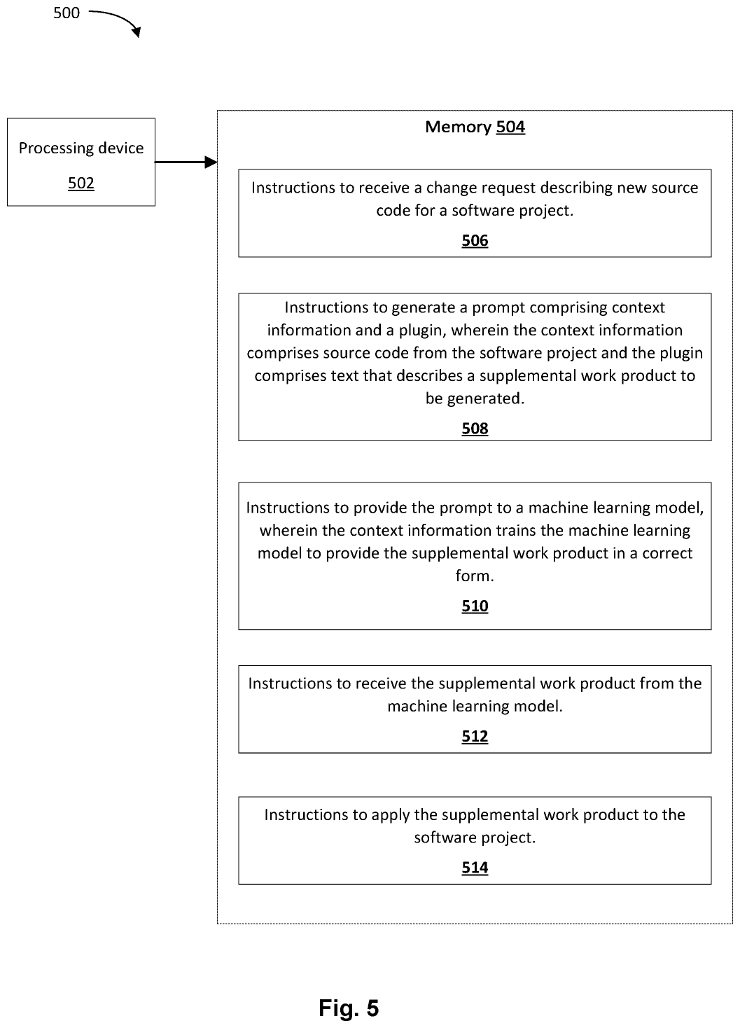

FIG. 5 is a block diagram of a system for committing a change request to a codebase of a software project, in accordance with some embodiments of the present disclosure. The system 500 includes a processing device 502 operatively coupled to a memory 504. The memory 504 includes instructions that are executable by the processing device 502 to cause the processing device 502 to automatically generate a prompt for eliciting supplemental work product for the change request in accordance with embodiments described herein.

The memory 504 includes instructions 506 to receive a change request describing new source code for a software project. The memory 504 also includes instructions 508 to generate a prompt comprising context information and a plugin, wherein the context information comprises source code from the software project and the plugin comprises text that describes a supplemental work product to be generated. The memory 504 also includes instructions 510 to provide the prompt to a machine learning model, wherein the context information trains the machine learning model to provide the supplemental work product with a correct content and format. The memory 504 also includes instructions 512 to receive the supplemental work product from the machine learning model. The memory 504 also includes instructions 514 to apply the supplemental work product to the software project. It will be appreciated that various alterations may be made to the process illustrated in FIG. 5 and that some components and processes may be omitted or added without departing from the scope of the disclosure.

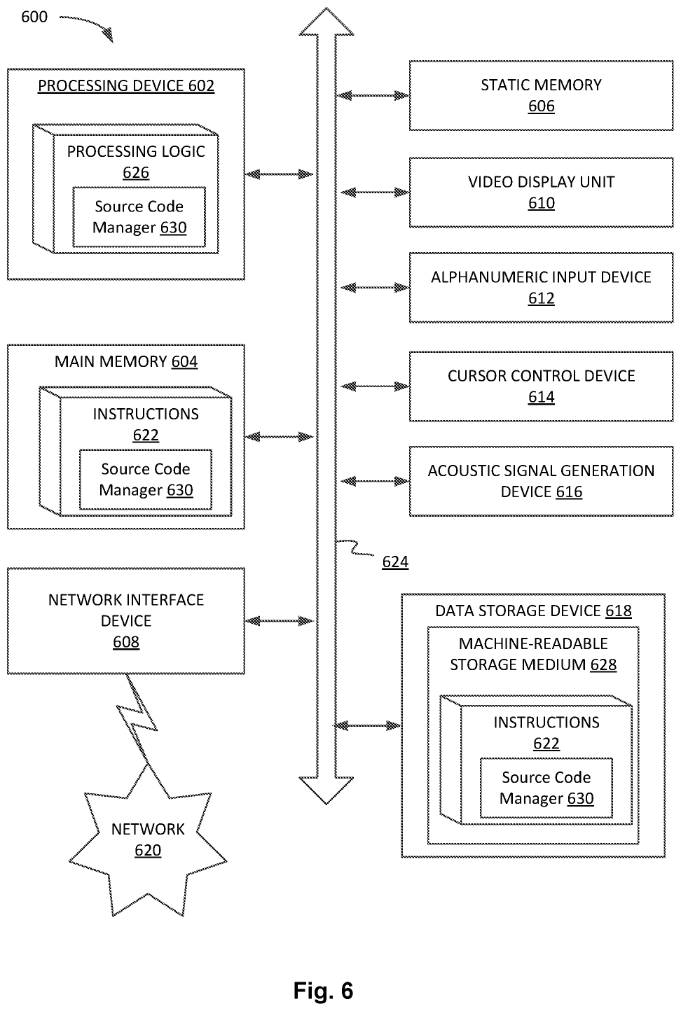

FIG. 6 is a block diagram of an example computing device 600 that may perform one or more of the operations described herein, in accordance with some embodiments of the present disclosure. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a server, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device (e.g., a general purpose processor, a PLD, etc.) 602, a main memory 604 (e.g., synchronous dynamic random access memory (DRAM), read-only memory (ROM)), a static memory 606 (e.g., flash memory) and a data storage device 618, which may communicate with each other via a bus 624.

Processing device 602 may be provided by one or more general-purpose processing devices such as a microprocessor, central processing unit, or the like. In an illustrative example, processing device 602 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also comprise one or more special-purpose processing devices such as an application specific integrated circuit (ASIC), a field programmable gate array (FPGA), a digital signal processor (DSP), network processor, or the like. The processing device 602 may be configured to execute the operations described herein, in accordance with one or more aspects of the present disclosure, for performing the operations and steps discussed herein.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Data storage device 618 may include a computer-readable storage medium 628 on which may be stored one or more sets of instructions 622 that may include a source code manager 630 comprising instructions for carrying out the operations described herein, in accordance with one or more aspects of the present disclosure. The source code manager 630 may also reside, completely or at least partially, within main memory 604 and/or within processing device 602 (e.g., within processing logic 626) during execution thereof by computing device 600, main memory 604 and processing device 602 also constituting computer-readable media. The source code manager 630 may further be transmitted or received over a network 620 via network interface device 608.

While computer-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “sending,” “receiving,” “establishing,” “determining,” “identifying,” “generating,” “transferring,” “applying,” “providing,” “adding,” “committing,” “testing” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware--for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
receiving a change request describing new source code for a software project;
generating, by a processing device, a prompt comprising context information and a plugin, wherein the context information comprises source code from the software project and the plugin comprises text that describes a supplemental work product to be generated;
providing the prompt to a machine learning model, wherein the context information trains the machine learning model to provide the supplemental work product with a correct content and format;
receiving the supplemental work product from the machine learning model; and
applying the supplemental work product to the software project.

2. The method of claim 1, wherein generating the prompt comprises selecting the plugin from a set of predetermined plugins based on characteristics of the change request.

3. The method of claim 1, wherein the change request comprises a difference file describing the new source code as code differences relative to a current version of the source code.

4. The method of claim 3, further comprising:
identifying units of the source code from the software project that are affected by the code differences; and
adding the identified units of the source code to the context information.

5. The method of claim 1, wherein the supplemental work product received from the machine learning model is a supplemental difference patch, and wherein applying the supplemental work product to the software project comprises processing the supplemental difference patch.

6. The method of claim 1, wherein the supplemental work product received from the machine learning model is included in a combined difference patch, and wherein applying the supplemental work product to the software project comprises processing the combined difference patch to apply the new source code and the supplemental work product to the software project.

7. The method of claim 1, wherein the machine learning model is a large language model (LLM).

8. The method of claim 1, wherein the supplemental work product comprises software tests to be used to test the new source code.

9. The method of claim 1, wherein the supplemental work product comprises code documentation describing code changes applied by the change request.

10. A system comprising:
a memory; and
a processing device, operatively coupled to the memory, the processing device to:
receive a change request describing new source code for a software project;
generate a prompt comprising context information and a plugin, wherein the context information comprises source code from the software project and the plugin comprises text that describes a supplemental work product to be generated;
provide the prompt to a machine learning model, wherein the context information trains the machine learning model to provide the supplemental work product with a correct content and format;
receive the supplemental work product from the machine learning model; and
apply the supplemental work product to the software project.

11. The system of claim 10, wherein to generate the prompt comprises to select the plugin from a set of predetermined plugins based on characteristics of the change request.

12. The system of claim 10, wherein the change request comprises a difference file that describes the new source code as code differences relative to a current version of the source code.

13. The system of claim 12, wherein the processing device is further to:
identify units of the source code from the software project that are affected by the code differences; and
add the identified units of the source code to the context information.

14. The system of claim 10, wherein the supplemental work product received from the machine learning model is a supplemental difference patch, and wherein the processing device is to process the supplemental difference patch to apply the supplemental work product to the software project.

15. The system of claim 10, wherein the supplemental work product received from the machine learning model is included in a combined difference patch, and wherein the processing device is to process the combined difference patch to apply the new source code and the supplemental work product to the software project.

16. A non-transitory computer-readable storage medium including instructions that, when executed by a processing device, cause the processing device to:
receive a change request describing new source code for a software project;
generate, by the processing device, a prompt comprising context information and a plugin, wherein the context information comprises source code from the software project and the plugin comprises text that describes a supplemental work product to be generated;
provide the prompt to a machine learning model, wherein the context information trains the machine learning model to provide the supplemental work product with a correct content and format;
receive the supplemental work product from the machine learning model; and
apply the supplemental work product to the software project.

17. The non-transitory computer-readable storage medium of claim 16, wherein to generate the prompt comprises to select the plugin from a set of predetermined plugins based on characteristics of the change request.

18. The non-transitory computer-readable storage medium of claim 15, wherein the change request comprises a difference file that describes the new source code as code differences relative to a current version of the source code, and wherein the processing device is further to:
identify units of the source code from the software project that are affected by the code differences; and
add the identified units of the source code to the context information.

19. The non-transitory computer-readable storage medium of claim 15, wherein the supplemental work product received from the machine learning model is a supplemental difference patch, and wherein the processing device is to process the supplemental difference patch to apply the supplemental work product to the software project.

20. The non-transitory computer-readable storage medium of claim 15, wherein the supplemental work product received from the machine learning model is included in a combined difference patch, and wherein the processing device is to process the combined difference patch to apply the new source code and the supplemental work product to the software project.
